(19) United States
(12) Patent Application Publication
(10) Pub. No.: US 2007/0080177 A1
(43) Pub. Date: Apr. 12, 2007

(54) Fluid dispensing components

(75) Inventors: Jason D. Hatton, Essexville, MI (US); Steven R. Tuckey, Freeland, MI (US); John M. Hess III, Midland, MI (US)

Correspondence Address: WOOD, PHILLIPS, KATZ, CLARK & MORTIMER, 500 W. MADISON STREET, SUITE 3800, CHICAGO, IL, 60661, US

(73) Assignee: SEAQUIST CLOSURES FOREIGN, INC.

(21) Appl. No.: 11/634,664

(22) Filed: Dec. 6, 2006

Related U.S. Application Data
(62) Division of application No. 10/695,227, filed on Oct. 28, 2003.

(51) Int. Cl. B65D 37/00; B65D 35/38

(52) U.S. Cl. 222/207; 222/494

(57) ABSTRACT

Components are provided for use in systems for dispensing fluids. A resilient diaphragm is provided for a diaphragm pump. The diaphragm includes a pressurizing portion connected with a connecting member to a peripheral mounting flange for mounting the diaphragm in the housing of the pump. The pump housing has a retention wall which can be swaged against the diaphragm flange. The pump housing has a discharge structure with an outlet valve and a restraint structure adjacent the valve to prevent in-venting through the outlet valve. The outlet valve includes a flange which is retained by a retention wall and which projects from the discharge structure and which is swaged into engagement with the outlet valve flange.

### CROSS REFERENCE TO RELATED APPLICATION(S)

This is a divisional of U.S. patent application Ser. No. 10/695,227, filed Oct. 28, 2003.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to components for dispensing fluid, such as liquid. The components are particularly well suited for use in a diaphragm pump for dispensing liquid, such as hand soap.

### BACKGROUND OF THE INVENTION AND TECHNICAL PROBLEMS POSED BY THE PRIOR ART

There are a variety of components in use in various fluid dispensing systems. Fluid dispensing systems typically include a reservoir for fluid and a discharge structure which may be connected to the fluid reservoir directly or through a conduit.

One type of conventional fluid reservoir is a pressurizable cavity in a fluid dispensing pump which has a resiliently deformable diaphragm that defines a convex wall of the cavity into which fluid enters through a one-way inlet structure and from which fluid is discharged through an outlet discharge structure. Such a diaphragm is typically pushed inwardly to pressurize a fluid in the cavity and squeeze the fluid out of the cavity through the discharge structure of the pump. Such a diaphragm is typically mounted in the housing of the pump. The periphery of the diaphragm must be suitably retained by the pump housing to make a fluid-tight seal that will not fail when the maximum design force or pressure is applied to the diaphragm.

It would be desirable to provide an improved pump that readily facilitates relatively rapid and correct assembly of the diaphragm into the pump housing with a reduced number of separate parts and that also provides a retention system that is sufficient to maintain a fluid-tight seal between the housing and diaphragm when the pump diaphragm is subjected to its maximum design force or pressure.

Further, it would be beneficial to provide an improved design of the diaphragm per se which would readily accommodate proper placement of the diaphragm in the pump housing and which would withstand the installation and retention forces so as to reduce stress applied to the diaphragm.

It would also be advantageous to provide an improved discharge structure for a fluid dispensing system, including a fluid discharge structure that could be employed in, among other devices, a fluid dispensing container or fluid dispensing pump. Such an improved fluid discharge structure should advantageously include a one-way discharge valve system that (1) prevents in-venting of ambient atmosphere into the system, and (2) minimizes hydraulic hammer pressure or water hammer in the system on the outlet valve.

Further, it would be desirable if a discharge structure could be provided with a discharge valve having an improved design that readily accommodates mounting of the valve to one or more discharge structure components in a way that, inter alia, establishes a fluid-tight seal, reduces the number of separate parts, and provides retention forces sufficient to properly retain the valve.

Improved dispensing system components should also desirably withstand rugged handling or abuse without leaking.

Further, it would be desirable if such improved system components could accommodate efficient, high-quality, large volume manufacturing techniques with a reduced product reject rate.

The present invention provides improved dispensing system components which can accommodate designs having the above-discussed benefits and features.

### BRIEF SUMMARY OF THE INVENTION

The present invention provides improved components which can be employed in a fluid dispensing system. One aspect of the invention is a discharge structure for dispensing liquid from a supply of liquid. The discharge structure includes a discharge conduit defining a flow passage for establishing fluid communication with the liquid from the supply of liquid. The discharge structure includes a resilient valve that (1) extends across the discharge conduit flow passage in an initial, substantially non-deformed, closed configuration, (2) has an interior side for being contacted by the liquid and an exterior side exposed to the ambient external atmosphere, (3) has a head defining part of the interior side and defining a normally self-sealing closed orifice, and (4) a sleeve defining part of the interior side and extending from the periphery of the valve head to accommodate movement of the valve head outwardly to an open configuration when the pressure on a portion of the valve interior side exceeds the pressure on the valve exterior side by a predetermined amount. The discharge structure also includes a restraint structure disposed in the discharge conduit in contact with the valve interior side at the valve head when the valve is in the initial, substantially non-deformed, closed configuration. The restraint structure and the discharge conduit together defining at least one flow path for initially accommodating flow of the liquid from the supply against a portion of the valve interior side at the valve sleeve laterally beyond the valve head. The restraint structure prevents the closed orifice from opening inwardly when the ambient external pressure on the valve exterior side exceeds the pressure on the valve interior side. The restraint structure can also minimize the effects of hydraulic water hammer pressure on the outlet valve when the diaphragm dome is subjected to a high, rapidly applied actuating force.

Another aspect of the invention relates to a peripheral mounting flange of a resilient, pressure-actuatable valve that can discharge a fluid product in an outward flow direction and that has (1) a head defining a normally self-sealing closed dispensing orifice, and (2) a sleeve extending from the periphery of the head. The peripheral mounting flange is adapted for being retained by a retention wall of a valve holding structure wherein the retention wall is deformed against the peripheral mounting flange. The peripheral mounting flange includes a resilient material extending from the periphery of the sleeve in a generally annular configuration about a longitudinal axis that extends axially inwardly and axially outwardly relative to the flow direction. The generally annular configuration of material is located around and radially outwardly of the longitudinal axis. The resilient material has a surface region defined at least in part by the following surfaces as viewed in cross section:

a first surface extending generally axially outwardly from the sleeve; and

a second surface extending generally axially inwardly from the sleeve.

In a preferred embodiment, the flange also includes one or more of the following surfaces:

a third surface extending both generally axially outwardly and radially outwardly from the first surface;

a fourth surface extending both generally axially inwardly and radially outwardly from the second surface so that the third and fourth surfaces generally diverge;

a fifth surface extending from the third surface both generally axially inwardly and radially outwardly; and

a sixth surface extending from the fourth surface both generally axially outwardly and radially outwardly.

Another aspect of the invention relates to an improved diaphragm pump. The pump includes a diaphragm of resilient material molded to define a resiliently deformable pressurizing portion, a connecting member, and a mounting flange. The resiliently deformable, pressurizing portion includes an undeformed convex configuration as viewed from the exterior, and defines a concave receiving region as viewed from the interior for pressurizing fluid. The connecting member extends from the periphery of the pressurizing portion. The mounting flange (a) extends generally radially from the periphery of the connecting member, (b) is thicker than the connecting member, (c) has a first surface extending outwardly from the connecting member in the direction toward the exterior, and (d) has a second surface extending inwardly from the connecting member in the direction away from the exterior.

The improved pump further includes a pump housing defining an inlet and outlet. The pump housing includes a retention structure for retaining the diaphragm mounting flange. The retention structure includes a projecting wall that has a lateral surface and an end surface. When the pump is not pressurizing the fluid, the wall end surface is spaced from the diaphragm connecting member, and the wall lateral surface is spaced from the diaphragm mounting flange second surface. This arrangement facilitates assembly of the diaphragm into the pump housing.

Another aspect of the invention provides in improved diaphragm for a pump. The diaphragm is molded from a resilient material to define at least the following three features:

(A) a resiliently deformable, pressurizing portion that (1) has an undeformed convex configuration when viewed from the exterior, and (2) defines a receiving region under the convex configuration for receiving fluid that can be pressurized by deforming the pressurized portion;

(B) a stress isolation connecting member that (1) extends from the periphery of the pressurizing portion, and (2) has a non-linear cross-sectional configuration; and

(C) a mounting flange that (1) extends from the periphery of the stress isolation connecting member, and (2) can be disposed in a retention structure of the pump.

Yet another aspect of the invention also provides an improved diaphragm for a pump wherein the pump has a retention structure that includes an inelastically deformable exterior retention wall. The diaphragm includes a resilient material molded to define at least the following:

(A) a resiliently deformable, pressurizing portion that (1) has an undeformed convex configuration as viewed from the exterior, and (2) defines a concave receiving region as viewed from the interior for pressurizing fluid; and

(B) a mounting flange that (1) is connected with the periphery of the pressurizing portion, (2) can be disposed in the pump so that the exterior retention wall can be inelastically deformed against the mounting flange, and (3) has a generally annular configuration of resilient material extending from the periphery of the sleeve wherein the material has a surface region defined in part by the following surfaces:
(a) inner and outer diverging surfaces wherein the inner diverging surface is inwardly of the location of the connection of the flange to the pressurizing portion and wherein the outer diverging surface is outwardly of the location of the connection of the flange to the pressurizing portion;
(b) a first corner surface extending from the outer diverging surface;
(c) a laterally extending surface extending from the first corner surface; and
(d) a second corner surface extending from the laterally extending surface.

Numerous other advantages and features of the present invention will become readily apparent from the following detailed description of the invention, from the claims, and from the accompanying drawings.

### BRIEF DESCRIPTION OF THE DRAWINGS

In the accompanying drawings that form part of the specification, and in which like numerals are employed to designate like parts throughout the same,

FIG. 1 is a perspective view of a dispensing system comprising a plurality of components assembled to form a diaphragm pump for dispensing a liquid, and the pump is viewed from the actuation side of the pump from which the pump diaphragm projects;

FIG. 2 is a view of the reverse side of pump illustrated in FIG. 1;

FIG. 3 is an exploded, perspective view from the actuation side of the pump illustrated in FIG. 1 wherein the pump housing is shown in an as-molded condition with an upstanding retention wall prior to the diaphragm being inserted into the pump housing and prior to the retention wall being inelastically deformed over the flange of the diaphragm, and wherein the discharge structure outlet spout is shown in an as-molded condition with a projecting retention wall prior to the outlet valve being disposed in the spout and prior to the retention wall being inelastically deformed over the flange of the valve;

FIG. 4 is an exploded perspective view from the reverse side of the pump components illustrated in FIG. 2 wherein the components are shown in the as-molded condition prior to assembly;

FIG. 5 is a plan view from the actuation side of the fully assembled pump illustrated in FIG. 1;

FIG. 6 is a side elevational view of the fully assembled pump illustrated in FIG. 1;

FIG. 7 is a plan view of the reverse side of the pump shown in FIG. 5;

FIG. 8 is a bottom end view of the pump illustrated in FIG. 1;

FIG. 9 is a cross-sectional view taken generally along the plane 9-9 in FIG. 8;

FIG. 10 is a greatly enlarged, fragmentary view of the portion of the pump shown in FIG. 9 wherein the pump diaphragm flange is retained by an inelastically deformed wall of the pump housing;

FIG. 11 is a greatly enlarged, exploded, perspective view of the discharge spout assembly or discharge structure assembly of the pump shown in FIG. 3 with the components in the as-molded, unassembled condition;

FIG. 12 is an exploded, perspective view of the discharge spout assembly illustrated in FIG. 11, but in FIG. 12, the components of the assembly are viewed from the bottom;

FIG. 13 is a plan view of the exterior side of the outlet valve illustrated in FIGS. 11 and 12;

FIG. 14 is a cross-sectional view taken generally along the plane 14-14 in FIG. 13;

FIG. 15 is a greatly enlarged, fragmentary, cross-sectional view of the end of the pump discharge structure illustrated in FIG. 9 which is taken generally along the plane 9-9 in FIG. 8;

FIG. 16 is a view similar to FIG. 15, but FIG. 16 is taken along the plane 16-16 in FIG. 8;

FIG. 17 is a cross-sectional view taken generally along the plane 17-17 in FIG. 16;

FIG. 18 is a view similar to FIG. 1, but FIG. 18 shows the pump actuated to discharge or dispense liquid from the discharge end of the pump;

FIG. 19 is a cross-sectional view similar to FIG. 9, but the diaphragm is shown as being actuated or pushed in as in FIG. 18 so as to dispense liquid from the pump through the open outlet valve;

FIG. 20 is a greatly enlarged view of the outlet end or discharge end of the pump taken generally along the plane 16-16 in FIG. 8 with the pump being actuated as shown in FIG. 19; and

FIG. 21 is a view similar to FIG. 19, but FIG. 21 shows the pump after the pushing force on the diaphragm has been released, after the outlet valve has closed, and after the diaphragm inlet valve has opened to permit liquid to flow into the diaphragm pressurizing cavity to refill the pump.

### DETAILED DESCRIPTION

While this invention is susceptible of embodiment in many different forms, this specification and the accompanying drawings disclose only specific forms of various aspects of the invention. The invention is not intended to be limited to the embodiments so described, however. The scope of the invention is pointed out in the appended claims.

For ease of description, the components and assemblies of this invention are described in an upright position, and terms such as upper, lower, horizontal, etc., are used with reference to this position. It will be understood, however, that the components and assemblies of this invention may be manufactured, stored, transported, used, and sold in an orientation other than the upright position described herein.

The components of this invention may be employed in various fluid dispensing systems, particularly liquid dispensing systems. Various components of the present invention are particularly well-suited for use in a discharge structure which may be connected to a fluid supply directly or through a conduit. The components of the present invention are especially useful in a fluid dispensing pump which contains a fluid reservoir in the form of a pressurizable cavity having an inlet and an outlet. Aspects of the invention are especially suitable for use with a diaphragm type dispensing pump which has a resiliently deformable diaphragm that defines a convex wall of the cavity into which fluid enters though a one-way valve inlet structure and from which fluid is discharged through an outlet discharge structure. Such a diaphragm is typically pushed inwardly to pressurize the fluid in the cavity and to squeeze the fluid out of the cavity through the discharge structure.

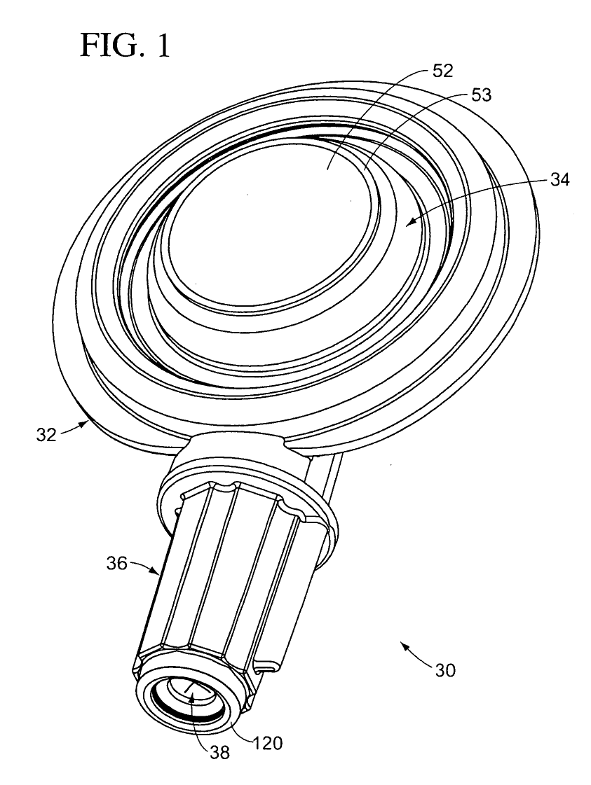

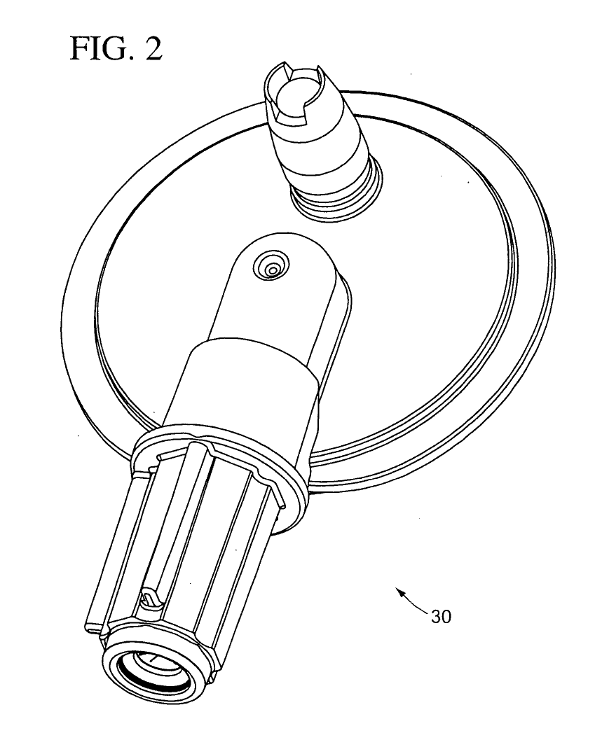

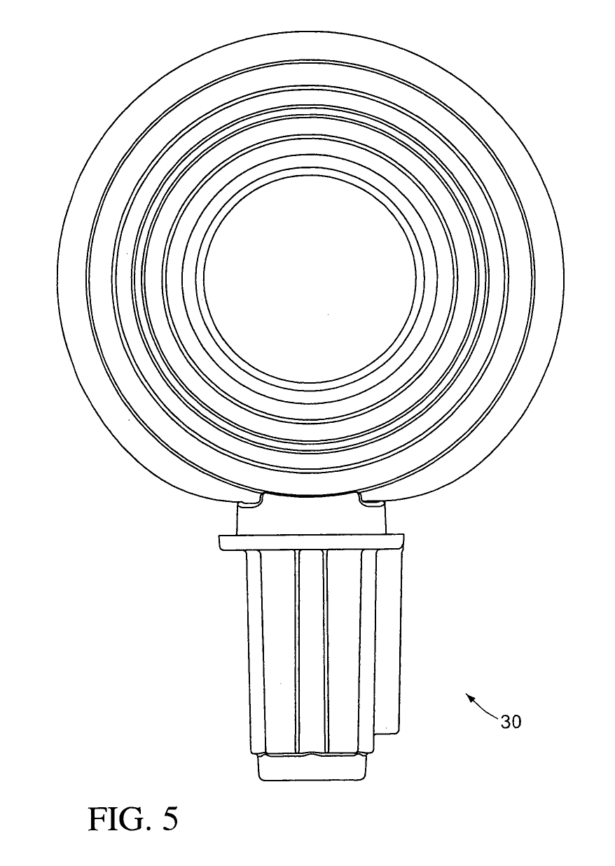

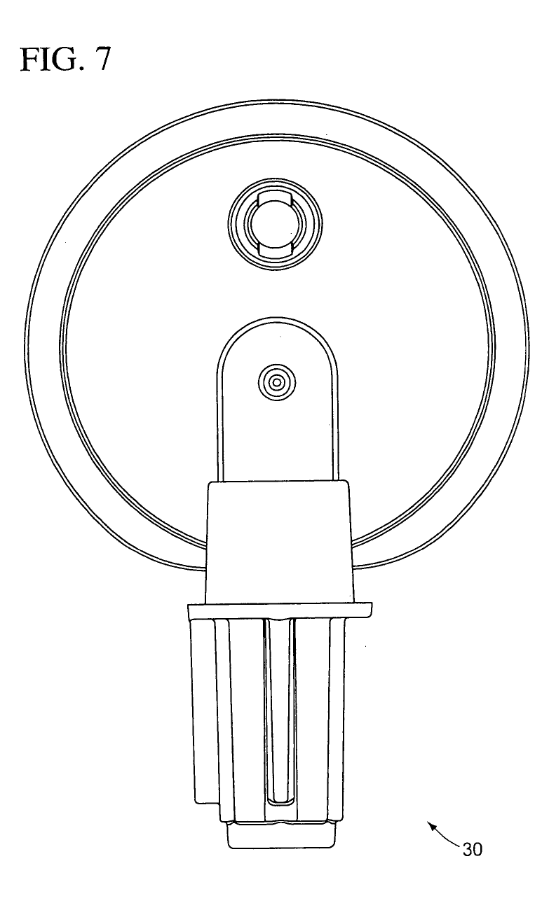

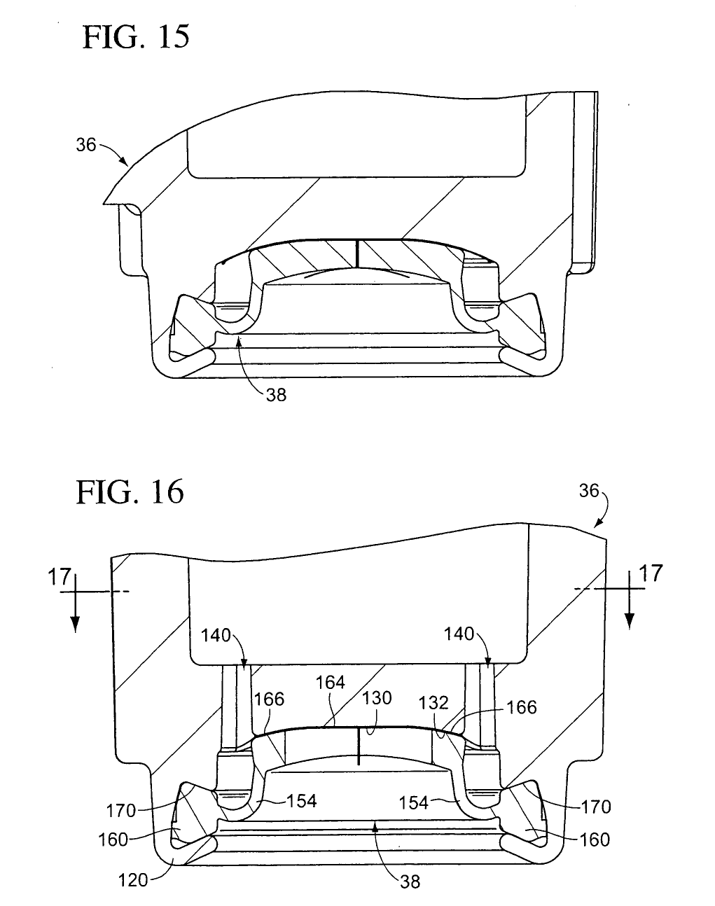

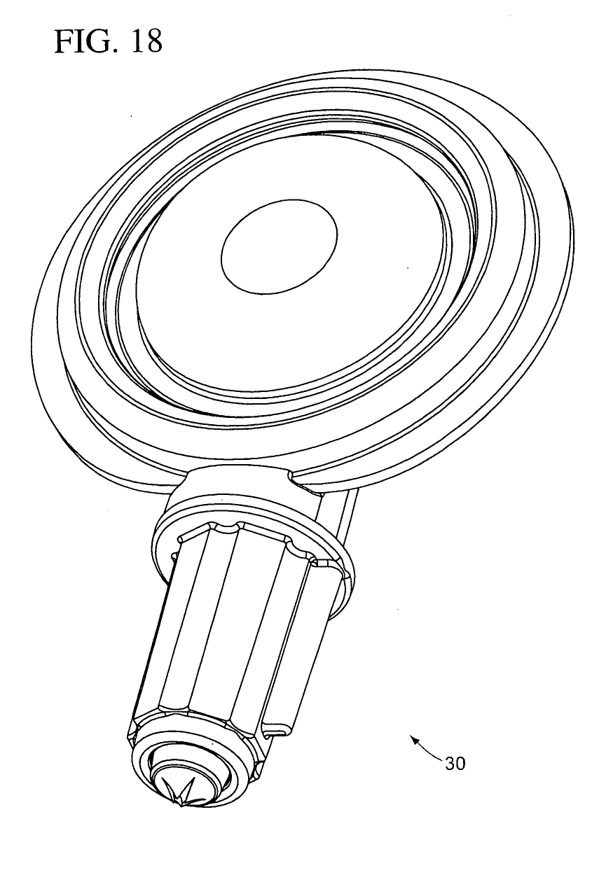

The fluid dispensing components of the present invention are particularly well suited for use in a diaphragm pump, and one presently preferred form of a diaphragm pump is illustrated in FIGS. 1-21. The pump is designated generally in many of those figures with the reference number 30. The pump 30 is especially suitable for use in a wall-mounted dispenser for soap, lotion, and hand care products.

In general, the operational aspects of the pump 30 are somewhat similar to those of the pump illustrated in the U.S. Pat. No. 6,216,916. The U.S. Pat. No. 6,216,916 illustrates a wall-mounted dispenser 10 in which is incorporated a pump comprising various major components, including a flexible diaphragm or dome 60 defining a pressurizing chamber 90, an inlet connection 52, and an outlet connection or spout 200.

In accordance with the teachings of the instant invention described herein, the pump 30 may be incorporated into a dispenser, like the dispenser 10 shown in U.S. Pat. No. 6,216,916, in an analogous manner to the above-described pump system disclosed in the U.S. Pat. No. 6,216,916.

The pump 30 illustrated in FIGS. 1-21 in the instant patent application may also be used in other suitable dispensers or other, different fluid dispensing systems. Further, some of the individual components or subassemblies of the pump 30 may, in accordance with the teachings of various aspects of the present invention, be incorporated in other types of fluid dispensing systems that do not contain a pump.

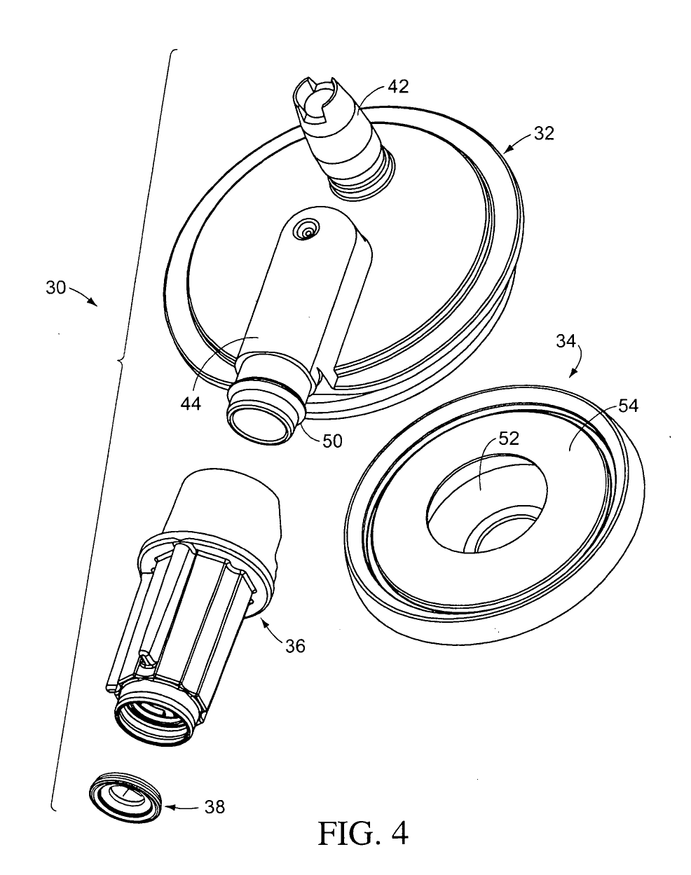

As can be seen in FIG. 4, the pump 30 employs an improved design that includes only four separate pieces: (1) a generally rigid pump body 32, (2) a resiliently deformable, pressurizing dome or diaphragm 34, (3) an outlet spout or conduit 36, and (4) a dispensing valve, discharge valve, or outlet valve 38. Together, the spout or discharge conduit 36 and valve 38 may be characterized as a discharge structure or discharge subassembly of the pump 30.

The pump body or housing 32 includes a fluid inlet structure or conduit 42. The conduit 42 accommodates flow of a liquid from a suitable supply of liquid into the pump. For example, the conduit 42 could be connected to a collapsible bag (not illustrated) that contains liquid soap.

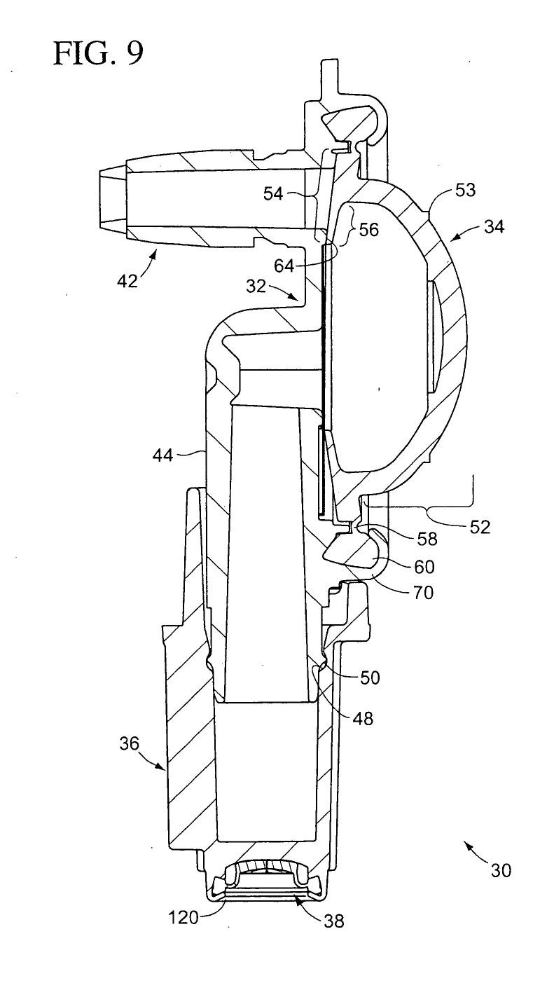

The pump body or housing 32 also includes a hollow boss 44 defining a an internal outlet passage communicating with the spout or discharge structure 36. The discharge structure 36 is designed to be assembled with a snap-fit engagement to the end of the boss 44 as shown in FIG. 9. To this end, the inlet end of the spout 36 includes an annular channel 48 for snap-fit engagement with an annular bead 50 on the pump housing boss 44 as shown in FIG. 9. The two parts are designed to be matingly engaged to form a fluid-tight connection. The particular detailed design of the snap-fit engagement and of the internal mating configuration may be of any suitable conventional or special design.

There is also a second engagement between the two parts defined by a taper fit on the distal end of pump housing boss 44 and a taper fit at the mating portion of the spout 36 as can be seen in FIG. 9.

Both the pump housing 32 and the mating spout 36 (but not the outlet valve 38 and diaphragm 34) are preferably molded from a homopolymer of polypropylene.

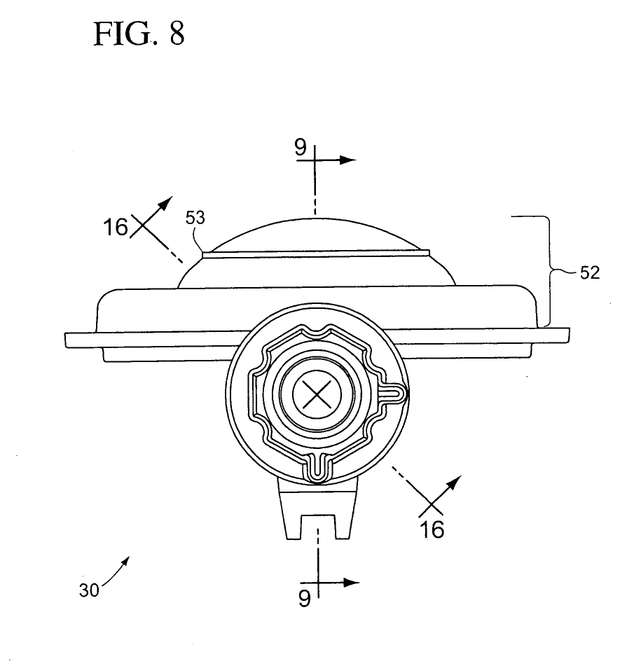

The diaphragm or membrane 34 is generally dome-shaped and has a central convex configuration or dome 52 (FIGS. 8 and 9) as viewed from the exterior of the pump. The diaphragm 34 defines a concave cavity or reservoir on the inside that functions, in cooperation with the pump housing 32, to hold the liquid which flows into the pump through the inlet conduit 42. The dome 52 can be deformed inwardly to pressurize the liquid. The dome 52 may be characterized as a resiliently deformable pressurizing portion. It need not have an arcuate, dome shape per se. It could have other suitable configurations defining a pressurizable cavity.

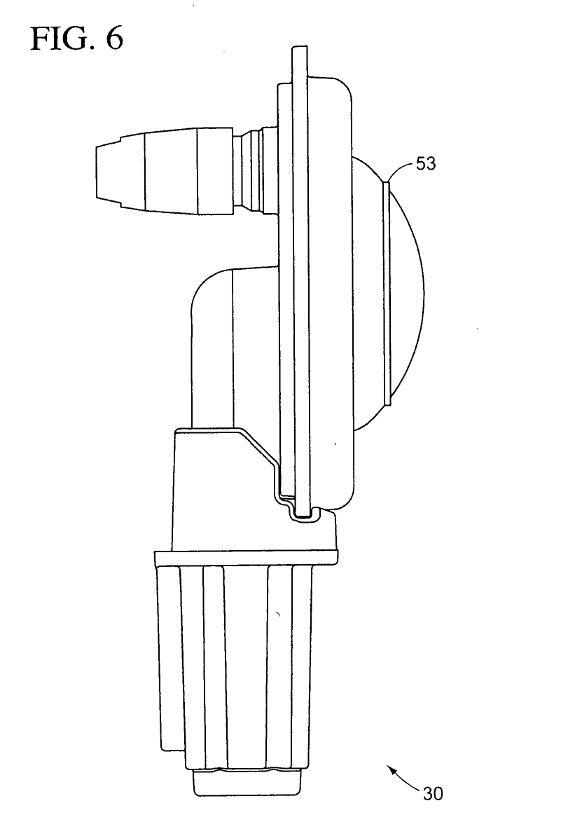

The exterior side of the dome 52 includes a step or ridge 53 (FIGS. 6 and 9) which accommodates the use of configuration mold parts that are more robust. The ridge is not needed for proper functioning of the dome 52 per se.

The diaphragm 34 is preferably molded from a resilient material which may be an elastomer, such as a synthetic thermosetting polymer, including silicone rubber, such as the silicone rubber sold by Dow Corning Corp. in the United States of America under the trade designation D.C. 9280-70. Another suitable silicone rubber product is sold by Wacker Silicone Company in the United States of America, under the designation Wacker 3003-70A. Both of these materials have a hardness rating of 70 Shore A. The diaphragm 34 can also be molded from other thermosetting materials or from other elastomeric materials, or from thermoplastic polymers or thermoplastic elastomers, including those based upon materials such as thermoplastic propylene, ethylene, urethane, and styrene, including their halogenated counterparts.

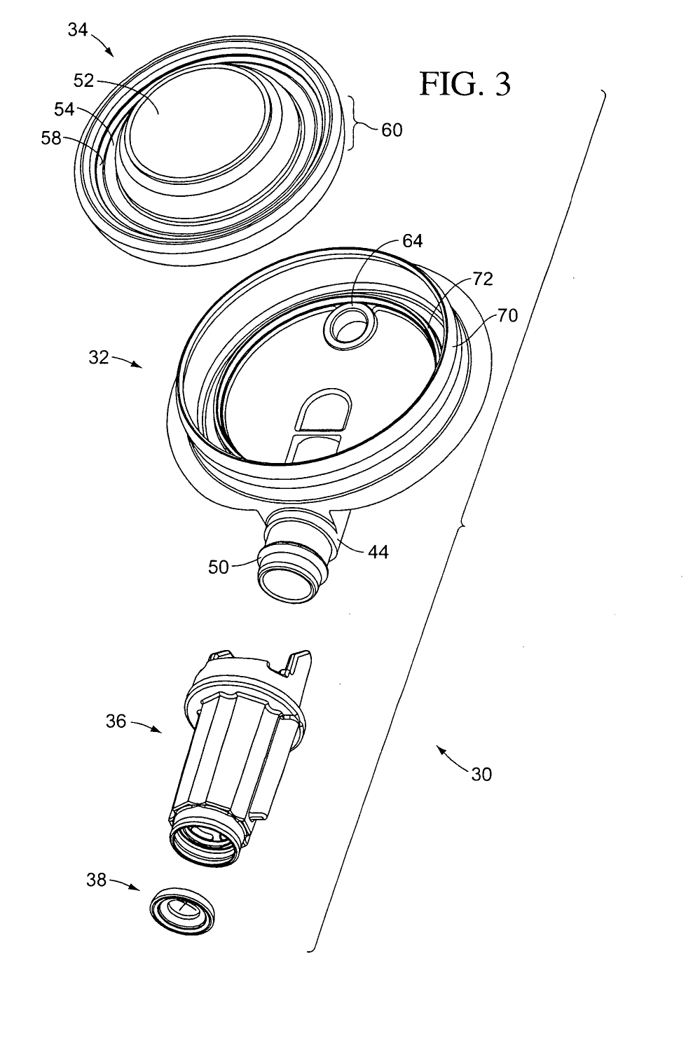

Owing to the unique configuration of the diaphragm 34, the diaphragm 34 normally remains in the undeformed configuration shown in FIGS. 1, 8, and 9, and this is a “self-maintained,” unactuated configuration. As shown in FIGS. 3, 4, and 9, the diaphragm 34 includes an annular base wall 54 around the bottom of the pressurizing portion or dome 52. As shown in FIG. 9, the portion of the annular base wall 54 that projects radially inwardly from the dome 52 defines a resilient, flexible flap 56.

As can be seen in FIGS. 3, 9, and 10, the outer periphery of the diaphragm base wall 54 terminates in, and merges with, an annular connecting member 58. In the preferred embodiment, the connecting member 58 performs a stress isolation function as is described in detail hereinafter. The connecting member 58 connects the diaphragm base wall 54 with a mounting flange 60. The mounting flange 60 is adapted to be retained by the pump housing 32 (FIG. 9) as described in detail hereinafter.

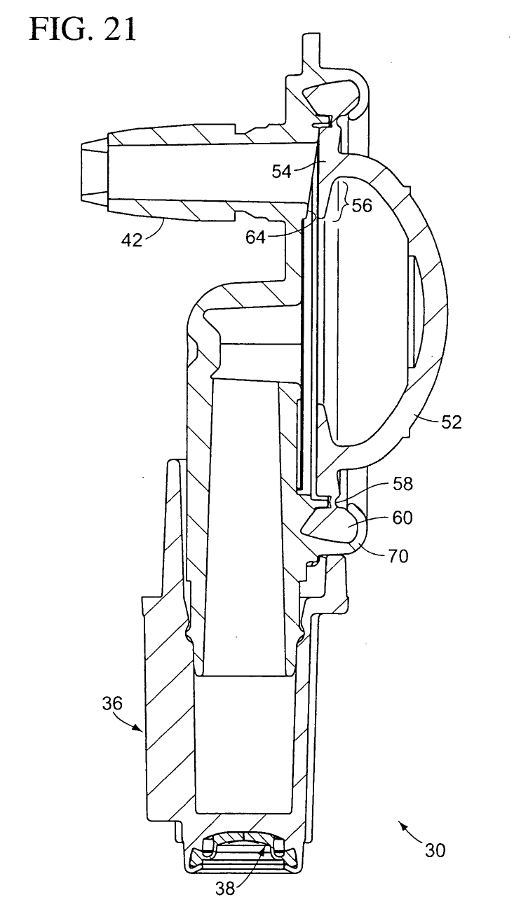

As can be seen in FIGS. 3 and 9, the pump housing 32 defines an annular surface functioning as an inlet valve seat 64 at the inner end of the inlet conduit 42. The inlet valve seat 64 is adapted to be sealingly engaged by the inner surface of the diaphragm base wall 54 when the pressure within the cavity of the diaphragm 34 equals or exceeds the pressure of the liquid in the conduit 42. If the pressure of the liquid in the conduit 42 exceeds the pressure within the cavity of the diaphragm 34 by a sufficient amount (as during the reduction of pressure in the cavity below the pressure in the inlet conduit 42), then the resilient, flexible flap 56 of the diaphragm base wall 54 is forced away from the valve seat 64 as illustrated in FIG. 21, and this permits the fluid in the inlet conduit 42 to flow into the cavity within the diaphragm 34 as shown in FIG. 21.

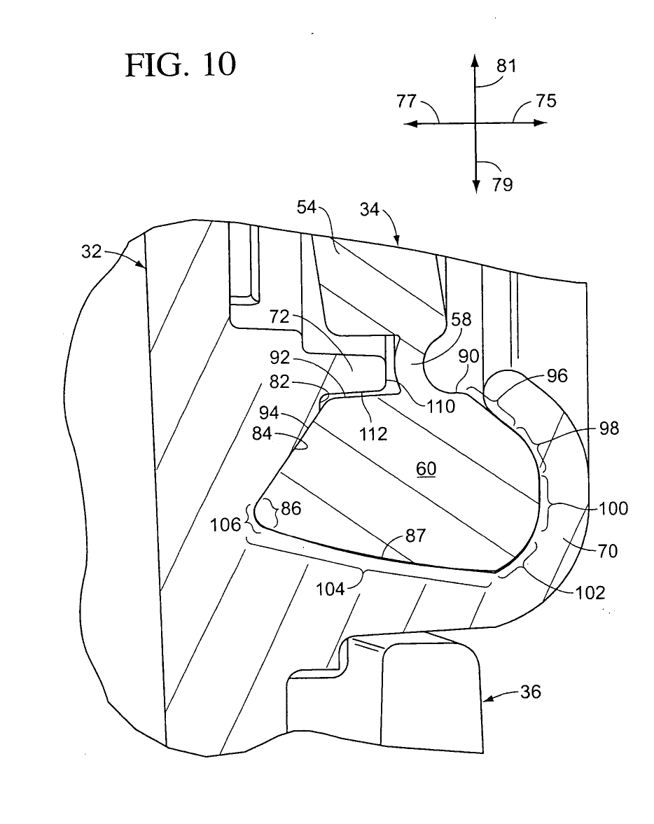

As can be seen in FIG. 3, the pump housing 32 is initially molded from a suitable thermoplastic material so as to have a configuration for receiving the diaphragm 34. To this end, the pump housing 32 has an “as-molded” configuration wherein there is an outwardly projecting, inelastically deformable, exterior, retention wall 70. As can be seen in FIGS. 3 and 10, the pump housing 32 also includes an annular inner projecting wall 72. The annular space between the inner projecting wall 72 and the exterior retention wall 70 functions as an annular receiving region for receiving and holding the diaphragm mounting flange when the diaphragm 34 is installed in the pump housing 32.

After the diaphragm 34 is properly placed in the housing so that the mounting flange 60 is disposed between the pump housing inner projecting wall 72 and the exterior retention wall 70, the exterior retention wall 70 is inelastically (i.e., plastically) deformed into the configuration illustrated in FIGS. 9 and 10. When the exterior retention wall 70 is in the “as-molded” outwardly projecting orientation as shown in FIG. 3 prior to deformation of the wall 70, the wall 70 can be heated and then deformed into the configuration illustrated in FIG. 10. The heating may be effected by any suitable process.

In one presently preferred process for heating and deforming the wall 70, the wall 70 is deformed with an ultrasonic horn (not illustrated) which heats the wall 70 by means of ultrasonic energy and also forces the wall to deform into the configuration shown in FIG. 10. This process is known as ultrasonic swaging.

The exterior curvature of the deformed wall 70 is substantially defined by the shape of a concave forming surface in the ultrasonic horn. The horn has a generally cylindrical end for engaging the wall 70. The concave surface in the horn defines an annular, downwardly open channel for receiving and engaging the wall 70. The horn is connected in a conventional manner to a conventional ultrasonic thruster assembly (not illustrated).

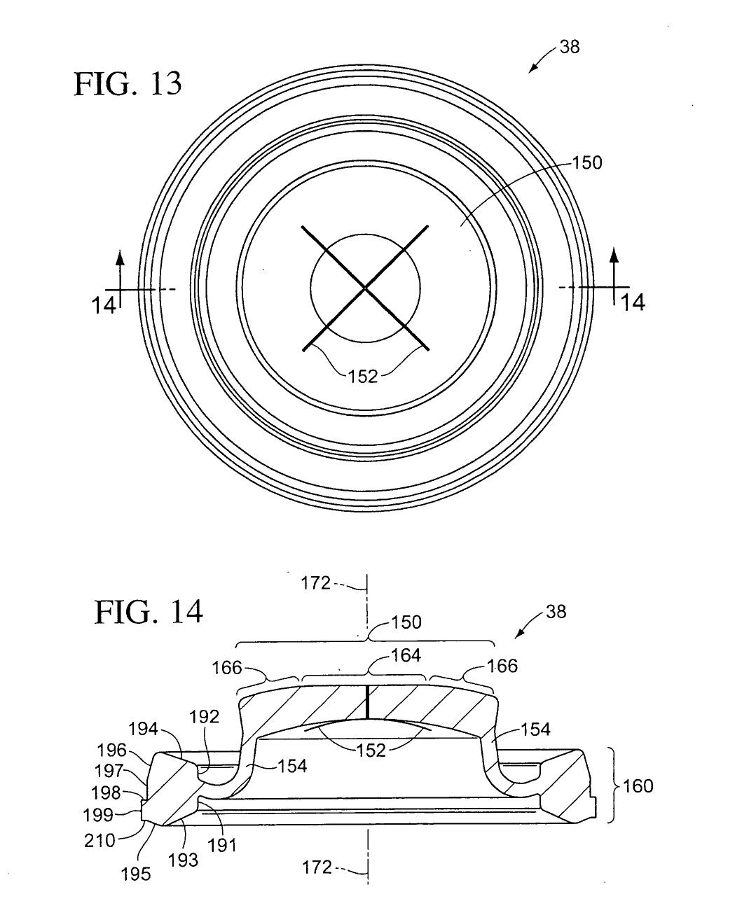

Ultrasonic deformation of a retention wall about a flange of resilient material is described in detail in the U.S. Pat. No. 5,115,950, at columns 5 and 6 thereof. Ultrasonic deformation of a wall about the flange of a resilient member is also described in U.S. Pat. No. 6,273,307 with reference to FIG. 13 therein. The description of the ultrasonic swaging process and apparatus disclosed in the U.S. Pat. No. 5,115,950 is incorporated herein by reference to the extent pertinent and to the extent not inconsistent herewith.

Preferably, to ultrasonically deform the retention wall 70 to the configuration illustrated in FIG. 10 with an ultrasonic swaging apparatus, the ultrasonic horn of the apparatus is moved into engagement with the initially outwardly projecting wall 70 so as to apply a force while actuating the ultrasonic system to apply ultrasonic energy until one of the following two conditions first occurs:
(1) the ultrasonic horn reaches a predetermined location relative to the diaphragm flange 60 (i.e., a predetermined maximum extension distance of the horn relative to the stationary part of the ultrasonic apparatus); or
(2) the lapsing of 2½ seconds.

In a presently preferred process, this results in the application of a swaging force of about 680 pounds to the wall 70. Then the ultrasonic energy is switched off, and the horn is retracted. After the wall 70 has been properly deformed into the configuration illustrated in FIG. 10, there is a very slight bit of compression force on the diaphragm flange 60, but the compression force is so slight that there is virtually no deformation of the flange 60 as compared to the “as-molded” shape of the flange.

The pump housing 32 and the diaphragm flange 60 each have configurations which facilitate relatively rapid and proper mounting of the diaphragm 34 within the pump housing 32 and which facilitate the subsequent deformation of the retention wall 70 so as to provide a sufficiently strong retention engagement to prevent diaphragm pull-out when the diaphragm is subjected to the maximum design pressure. If the pump is used in a hand soap dispenser, such as generally illustrated in the above-discussed U.S. Pat. No. 6,216,916, then a typical maximum design pressure for the internal pump components, including the diaphragm, could be about 50 pounds per square inch gauge.

As can be seen in FIG. 10, the pump housing 32 has a channel defined between the inner wall 72 and the exterior wall 70. For convenient reference, FIG. 10 illustrates four arrows: arrow 75, arrow 77, arrow 79, and arrow 81. Arrow 75 illustrates the generally axially outward direction relative to the diaphragm 34 and relative to the diaphragm flange 60. Arrow 77 represents the generally axially inward direction relative to the diaphragm 34 and its flange 60. Arrow 79 represents the generally radially outward direction relative to the diaphragm and its flange 60. Arrow 81 represents the generally radially inward direction relative to the diaphragm 34 and its flange 60.

In the following discussion and in the claims, the surfaces of the channel and flange 60 are described with reference to the cross section view taken radially through the channel and flange (e.g., FIGS. 9 and 10).

The channel is defined at least in part by a first, generally radial or vertical surface 82 and a second angled surface 84. The angled surface 84 may be characterized as extending both (1) generally axially inwardly (in the direction of arrow 77 and relative to the actuation side of the pump from which the diaphragm dome projects), and (2) radially outwardly (in the direction of arrow 79 and relative to the center of the diaphragm). At the lower end of the angled surface 84 is an interior corner or curved surface 86 which merges with a radially inwardly facing, slightly curved or concave surface 87 on the inside of the retention wall 70. The surface 87 extends somewhat radially outwardly (relative to the diaphragm and in the direction of arrow 79) from the corner 86 and extends from the curved corner surface 86 in a direction that is generally axially outwardly (in the direction of arrow 75) toward the actuation side of the pump from which the diaphragm projects. The distal end portion of the pump housing retention wall 70 is deformed and bent over at the outer end of the surface 87.

The diaphragm flange 60 has a unique configuration to facilitate its placement within the pump housing 32 and to facilitate retention of the flange 60 in the housing 32. In particular, the diaphragm flange 60 has a surface region defined by the following surfaces shown in cross section FIG. 10:
(a) a generally straight, axially outwardly extending surface 90 that extends outwardly (in the direction of arrow 79) from the region where the connecting member 58 connects to the flange 60;
(b) a generally straight, inwardly extending surface 92 that extends axially inwardly (arrow 77) away from the region where the connecting member 58 connects to the flange 60;
(c) an inner diverging surface 94 extending both radially outwardly and axially inwardly from the surface 92, which is generally straight, and which is axially inwardly of the location of the connection of flange 60 to the connecting member 58;
(d) an outer diverging surface 96 which is generally straight, which extends both radially outwardly and axially outwardly from the surface 90, and which is axially outwardly of the location of the connection of the flange 60 to the connecting portion 58;
(e) a corner surface 98 extending from the outer diverging surface 96;
(f) a laterally extending surface 100 which extends from the first corner surface 98 and which extends laterally or radially outwardly (arrow 79) relative to the diaphragm;
(g) a second corner surface 102 which extends from the laterally extending surface 100; and
(h) a laterally peripheral surface 104 which extends from the second corner surface 102.

The edge of the peripheral surface 104 adjacent the second corner surface 102 may be defined as an outer margin that is axially outwardly and radially outwardly relative to the rest of the surface 104. The surface 104 extends from the second corner surface 102 both axially inwardly and radially inwardly to an inner margin that is connected via an exterior corner or curved surface 106 to the inner diverging surface 84. The edge of the peripheral surface 104 at the corner 106 may be characterized as an inner margin of the surface 104. Thus, the outer margin of the surface 104 along the second corner surface 102 is located laterally or radially further outwardly (arrow 79) from the diaphragm pressurizing portion (e.g. dome 52) than is the inner margin of the peripheral surface 104 at the corner 106.

The pump housing 32 is configured to facilitate assembly of the diaphragm 34 into the pump housing 32 and to facilitate receipt of the diaphragm flange 60. To this end, it will be noted that the pump housing inner wall 72 has a distal end 110 and a laterally outwardly facing lateral surface 112. When the pump housing outer retention wall 70 is properly deformed about the diaphragm flange 60 (FIG. 10 ), and when the pump is not being actuated to pressurize the liquid within the pump, then the following conditions preferably obtain:
(1) the diaphragm dome 52 and base wall 54 are not subjected to significant deformation or excessive stress,
(2) the inner surface of the diaphragm connecting member 58 is spaced from the pump housing inner wall end surface 110 as shown in FIG. 10, and
(3) the diaphragm flange inner surface 92 is spaced from the pump housing inner wall lateral surface 112 as shown in FIG. 10.

The spacing between the lateral surface 112 and the diaphragm flange surface 92 is especially desirable in accommodating installation of the diaphragm flange 60 into its proper location within the pump housing prior to deformation of the pump housing exterior retention wall 70 into engagement with the outer surface of the diaphragm flange 60.

When the pump is actuated, and especially if the actuation creates a relatively high pressure adjacent the diaphragm 34, a portion of the diaphragm flange wall 92 may engage the pump housing inner wall lateral surface 112, especially near the pump housing inner wall end surface 110. This engagement aids in preventing pull-out of the diaphragm flange 60. This insures that the diaphragm 34 will remain properly retained within the pump housing 32 and that a leak-tight sealing engagement will continue to exist within the pump.

The space between the inner surface of the diaphragm connecting member 58 and the pump housing inner wall end surface 110 permits the diaphragm 34 to be readily positioned in the pump housing 32 prior to the exterior retention wall 70 being deformed into engagement with the diaphragm flange 60. Further, the space between the connecting member 58 and the end surface 110 of the pump housing inner projecting wall 72 permits some amount of movement or flexing of the connecting member 58 during the following conditions:
(1) during placement of the diaphragm 34 within the pump housing,
(2) during subsequent deformation of the pump housing exterior retention wall 70 against the diaphragm flange 60, and
(3) during operation or actuation of the pump.

In some applications, especially applications where the pump maximum design pressure is relatively low, the inner projecting wall 72 may be omitted.

According to one aspect of the present invention, the connecting member 58 preferably functions as stress isolation feature. In the preferred form illustrated in FIG. 10, the connecting member 58 has an arcuate cross section. Further, in the most preferred form presently contemplated, the connecting member 58 has a uniform thickness over at least a major portion of its radial length (i.e., the length of the connecting member generally in the direction of the arrow 79 in FIG. 10). Further, the presently most preferred form of the connecting member 58 defines a concave annular channel around the diaphragm pressurizing portion as viewed from the exterior of the pump. The connecting member may be characterized, in its most preferred form illustrated in FIG. 10, as having a sideways oriented, generally U-shaped configuration.

The novel stress isolation connecting member 58 serves to isolate, or at least minimize the transfer of stress to, the portion of the diaphragm 34 which is radially inwardly of the diaphragm flange 60. This is especially important during the process of deforming or swaging the pump housing exterior retention flange 70 into engagement with the flange 60. It has been found that the action of deforming the retention wall 70 into engagement with the flange 60 can produce some amount of stress in the resilient material of the diaphragm. The arcuate configuration of the connecting member 58 has been found to be especially effective in minimizing the transfer of such stress into the interior portion of the diaphragm that extends radially inwardly from the connecting member 58.

The various unique surfaces of the diaphragm flange 60 provide various advantages. In particular, the surface 94 (FIG. 10A) matches the geometry of the adjacent pump housing surface 84 so as to minimize the likelihood of the flange 60 from shifting during assembly, and this also reduces the assembly effort relative to designs that would have a more complicated geometry.

The flange surface 104, and the mating, somewhat arcuate surface 87 of the pump housing outer retention wall 70 aid in the ultrasonic deformation process by directing ultrasonic energy in a way that improves the process of deforming the wall 70.

It can be seen in FIG. 10 that the inside surface 87 of the wall 70 has a configuration which is laterally further from the diaphragm dome (in the direction of the arrow 79 in FIG. 10) with increasing distance along the wall 70 from the bottom of the wall (at the corner 86) to the free end of the wall 70 which is deformed over and against the diaphragm flange 60. The shape of the retention wall inside surface 87 contributes to an overall tapering or thinning of the base portion of the wall and facilitates the deformation of the outer portion of the wall 70 in the desired, deformed configuration.

The diaphragm flange corner surface 102 is preferably rounded as illustrated in FIG. 10 but may also be generally straight and angled. The surface 102 matches the geometry in that region of the diaphragm flange 60 to the inside surface geometry of the deformed retention wall 70 so as to enhance the retention of the diaphragm flange 60 and enhance the capability of the assembly to withstand the pull-out forces generated by the pressurization of the pump during the operation of the pump.

The diaphragm flange surface 100 is preferably generally straight, but also may be slightly curved. The surface 100 permits that region of the diaphragm flange 60 to match the geometry of the adjacent inner surface of the retention wall 70 to enhance retention of the diaphragm flange and to enhance the capability of the assembly to withstand pull-out forces generated by pressurization of the pump.

The diaphragm flange surface 98 is preferably slightly curved, but also may be straight. The surface 98 permits that region of the diaphragm flange 60 to match the geometry of the adjacent inner surface of the retention wall 70 to enhance retention of the diaphragm flange and to enhance the capability of the assembly to withstand pull-out forces generated by pressurization of the pump.

The diaphragm flange surface 96 is preferably generally straight, but also may be slightly curved. The surface 96 permits that region of the diaphragm flange 60 to match the geometry of the adjacent inner surface of the retention wall 70 to enhance retention of the diaphragm flange and to enhance the capability of the assembly to withstand pull-out forces generated by pressurization of the pump.

The novel discharge structure of the pump provides operational advantages as discussed hereinafter. The discharge structure may be characterized as including the assembly of the discharge conduit or spout 36 and the resilient, pressure-actuatable, outlet valve 38 as shown in FIGS. 9, 11, and 12. The discharge structure components (i.e., the spout 36 and valve 38) may be employed in dispensing systems other than a pump 30.

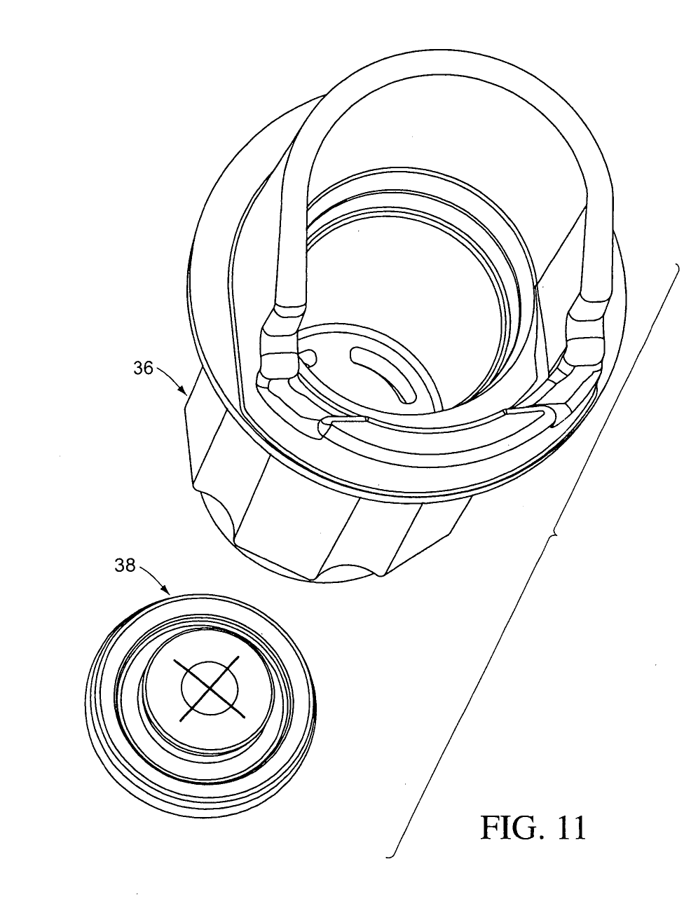

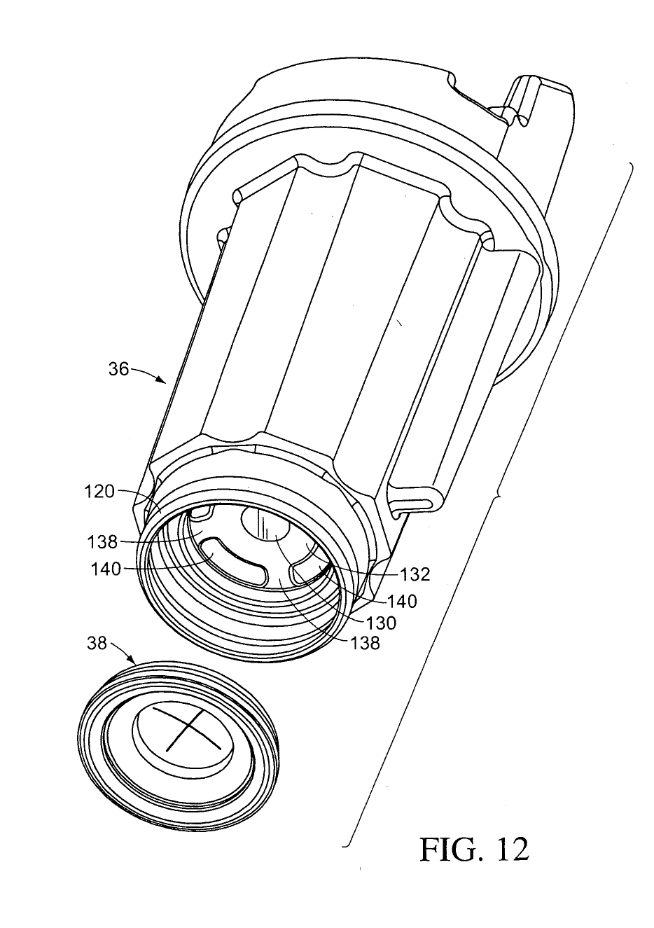

FIGS. 11 and 12 illustrate the discharge conduit or spout 36 in the “as-molded” configuration prior to deformation of the distal end of the spout 36 about the valve 38. As described hereinafter, the valve 38 is preferably provided with a unique flange structure to accommodate deformation of the distal end of the discharge conduit or spout 36 in a way that facilitates assembly and proper retention of the valve after deformation of the distal end portion of the spout 36. The valve flange also accommodates the establishment of a retention configuration that enhances the resistance against valve pull-out and that enhances the fluid-tight engagement between the valve 38 and the spout 36.

As illustrated in FIG. 12, the “as-molded” configuration of the discharge conduit or spout 36 has an outwardly projecting, inelastically deformable retention wall 120 for accommodating initial placement of the valve 38 in the end of the spout 36. Subsequently, the distal end portion of the retention wall 120 is swaged by inelastically deforming the wall over a peripheral portion of the valve 38 as described hereinafter.

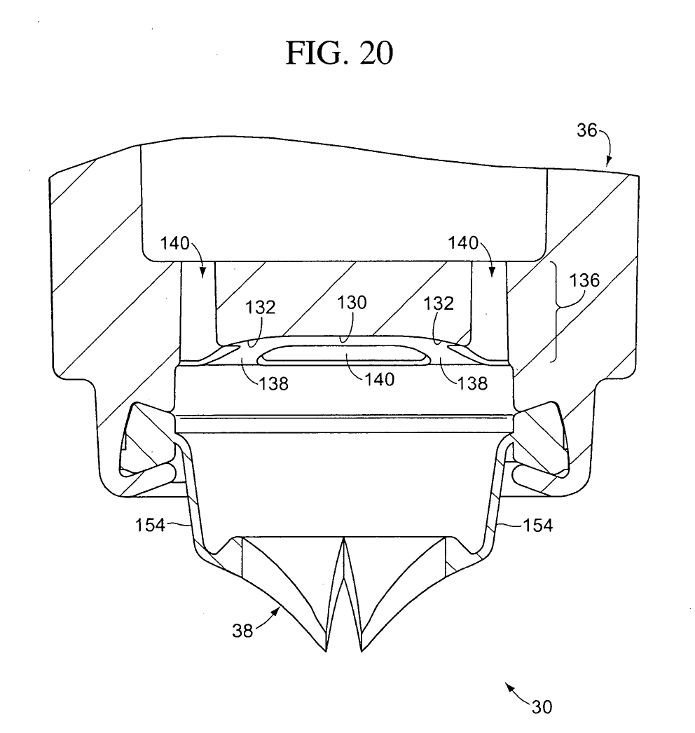

As illustrated in FIG. 12, the discharge conduit or spout 36 includes an inwardly recessed restraint structure for restraining movement of the valve 38 inwardly under certain conditions of operation as described hereinafter. As illustrated in FIGS. 12 and 20, the restraint structure defines (1) an imperforate, central, flat engaging surface 130, and (2) an imperforate, peripheral curved surface 132.

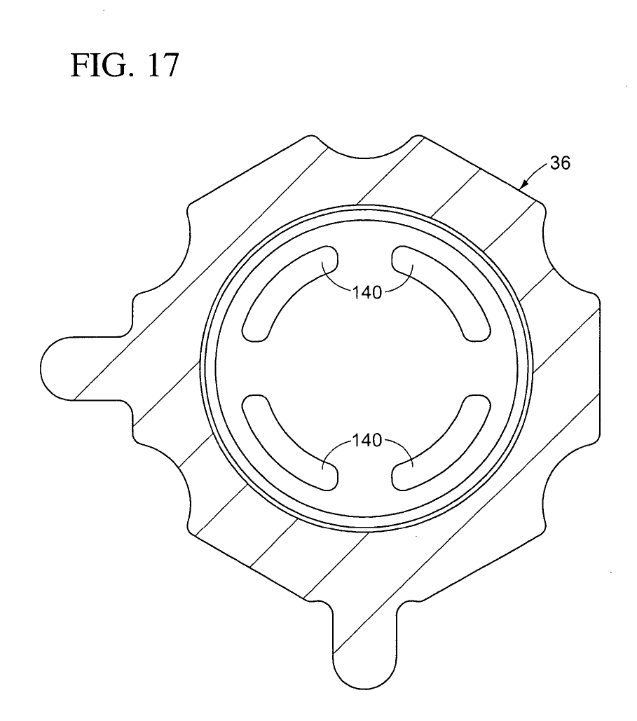

As can be seen in FIG. 20, the discharge conduit or spout 36 includes an annular wall 136, and a plurality of legs 138 connect the annular wall 136 with the restraint structure peripheral curved surface 132. A plurality of flow passages 140 are defined between the connecting legs 138. As can be seen in FIGS. 12 and 20, outwardly facing surface of each of the legs 138 is slightly angled or curved outwardly. With reference to FIG. 20, the flat surface 130, the curved surface 132, the legs 138, and the annular wall 136 together define the restraint structure for restraining the valve 38 against inward deformation or movement when the valve is properly installed and in the closed condition as shown in FIG. 16.

The discharge valve, dispensing valve, or outlet valve 38 is separately illustrated in FIGS. 13 and 14. In a presently preferred form, the valve is a “pressure-openable” valve which opens when a sufficient pressure differential is applied across the valve (e.g., as by increasing the pressure on one side and/or decreasing the pressure on the other side).

In the presently preferred form of the valve 38 illustrated in FIGS. 13 and 14, the valve 38 is molded as a unitary structure from material which is flexible, 25 pliable, elastic, and resilient. This can include elastomers, such as a synthetic, thermosetting polymer, including silicone rubber, such as a silicone rubber sold by Dow Corning Corp. in the United States of America under the trade designation D.C. 99-595-HC. Another suitable silicone rubber material is sold in the United States of America under the designation Wacker 3003-40 by Wacker Silicone Company. Both of these materials have a hardness rating of 40 Shore A. The valve 38 could also be molded from other thermosetting materials or from other elastomeric materials, or from thermoplastic polymers or thermoplastic elastomers, including those based upon materials such as thermoplastic propylene, ethylene, urethane, and styrene, including their halogenated counterparts.

The design configuration of valve 38, and the operating characteristics thereof, are substantially similar to the configuration and operating characteristics of the valve designated by the reference number 3d in the U.S. Pat. No. 5,409,144. The description in that patent is incorporated herein by reference to the extent pertinent and to the extent not inconsistent herewith.

As illustrated in FIGS. 13 and 14 herein, the valve 38 includes a head or head portion 150 which is flexible and which has an outwardly concave configuration (as viewed from the exterior of the valve 38 when the valve 38 is mounted in the spout 36). The head 150 defines at least one, and preferably two, dispensing slits 152 extending through the head 150 to define a normally self-sealing closed orifice. The preferred form of the valve 38 has two, mutually perpendicular, intersecting slits 152 of equal length. The intersecting slits 152 define four, generally sector-shaped, flaps or petals in the head 150. The flaps open outwardly from the intersection point of the slits 152 in response to an increasing pressure differential of sufficient magnitude in the well-known manner described in the above-discussed U.S. Pat. No. 5,409,144.

The valve 38 has an interior side for facing generally into the spout 36 and an exterior side for facing generally outwardly from the spout 36. The interior side of the valve 38 is adapted to be contacted by the liquid, and the exterior side of the valve 38 is exposed to the ambient external atmosphere.

The valve 38 includes a thin skirt 154 which extends axially and radially outwardly from the valve head 150. The outer end portion of the skirt 154 terminates in an enlarged, much thicker, peripheral flange 160 which has a generally dovetail shaped transverse cross section.

With reference to FIG. 14, the interior side of the valve head 150 includes a circular, central, flat surface 164 and a peripheral, curved surface 166 around the central flat surface 164. The slits 152 extend laterally from the valve head central, flat surface 164 into the valve head peripheral, curved surface 166.

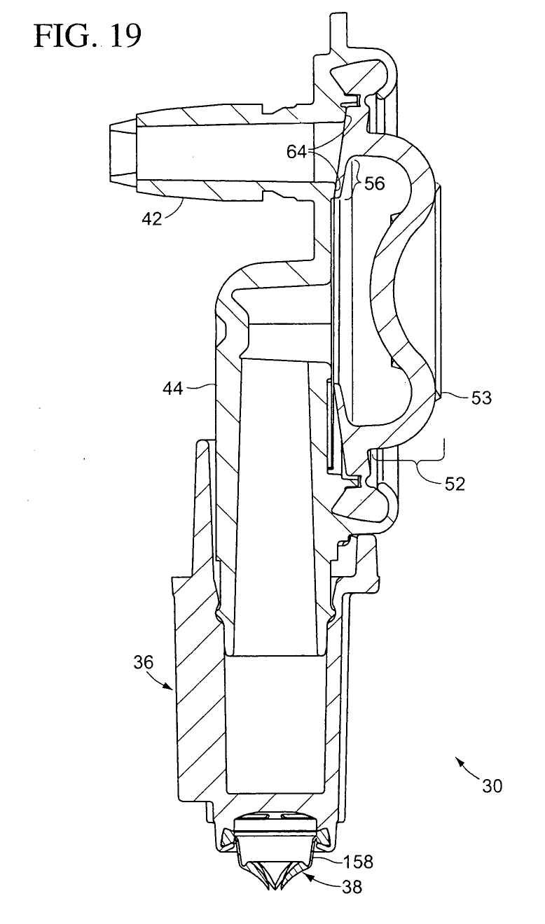

When the valve 38 is properly disposed in the discharge conduit 36 (FIGS. 9, 15, 16, 20, and 21) with the valve head 150 in the closed condition, the valve 38 is recessed relative to the end of the spout 36. However, when the head 150 is forced outwardly from its recessed position by pressurized liquid, the valve opens as shown in FIGS. 19 and 20. More specifically, when the pressure on the interior side of the valve 38 exceeds the external ambient pressure by a predetermined amount, the valve 38 is forced outwardly from the recessed or retracted position to an extended, open position as shown in FIGS. 18, 19, and 20.

During the valve opening process, the valve head 150 is initially displaced outwardly while still maintaining its generally concave, closed configuration. The initial outward displacement of the concave head 150 is accommodated by the relatively, thin, flexible, skirt 154. The skirt 154 moves from a recessed, rest position to the pressurized position wherein the skirt 154 extends outwardly toward the open end of the spout 36. However, the valve 38 does not open (i.e., the slits 152 do not open) until the valve head 150 has moved substantially all the way to a fully extended position. Indeed, as the valve head 150 moves outwardly, the valve head 150 is subjected to radially inwardly directed compression forces which tend to further resist opening of the slits 152. Further, the valve head 150 generally retains its outwardly concave configuration as it moves forward and even after the sleeve 154 reaches the fully extended position. However, when the internal pressure becomes sufficiently great compared to the external pressure, then the slits 152 in the extended valve head 150 open to dispense product.

As can be seen in FIG. 16, the discharge spout 36 defines an annular valve seat 170 for receiving and engaging a portion of the valve flange 160 when the valve 38 is properly disposed within the distal end of the spout 36. When the valve 38 is properly disposed within the spout 36 as shown in FIG. 16, the valve head interior, central, flat surface 164 is seated against the spout mating, central, flat surface 130. Similarly, the peripheral curved surface 166 of the interior side of the valve head engages and seats on the spout peripheral curved surface 132.

The spout surfaces 130 and 132, which are part of the valve restraint structure of the discharge conduit or spout 36, prevent the valve head 150 from deflecting further inwardly into the spout 36. This prevents in-venting of ambient atmosphere through the valve 38 into the spout and pump whenever the ambient exterior atmospheric pressure exceeds the pressure within the spout 36. That would be an undesirable occurrence because subsequent operation of the pump to dispense the liquid would result in the discharge of a reduced amount of liquid together with the in-vented air.

With respect to FIG. 16, it can be appreciated that the flow paths 140 at the distal end of the spout 36 are arrayed laterally outwardly at, or beyond, the peripheral edge of the head 150 of the valve 38. Thus, virtually the entire interior surface of the valve head 150 can be supported or restrained against in-venting forces by the internal restraint structure in the spout 36.

When the liquid within the spout 36 is pressurized by the pump during actuation of the pump, the pressurized liquid in the flow passages 140 acts against the valve sleeve 154. When the pressure differential across the valve sleeve 154 is sufficiently great, the valve sleeve 154 is forced outwardly and carries the valve head 150 outwardly off of its seated engagement with the spout valve restraint surfaces 130 and 132. The liquid is then able to move between the interior surface of the valve head 150 and the spout valve restraint surfaces 130 and 132 so as to pressurize the interior surface of the valve head 150. This results in a greater total force on the interior surface of the valve 38, and the valve moves to the outwardly extended, open, dispensing position shown in FIG. 20.

FIG. 14 illustrates the novel, and advantageous profile configuration of the valve flange 160. The valve flange 160 readily accommodates proper assembly of the valve into the spout, accommodates the inelastic deformation or swaging of the spout retention wall 120 over the valve flange 160, and facilitates the establishment of an effective attachment of the valve 38 to the spout 36 in a way that provides enhanced resistance to valve pull-out and in a way that provides enhanced leak-tight sealing engagement between the valve flange 160 and the spout 36.

In the following discussion and in the claims, the surfaces of the valve flange 160 are described with reference to the cross section view taken radially through the valve 38 (FIGS. 14 and 16).

The flange 160 may be characterized as resilient material extending from the periphery of the sleeve 154 in a generally annular configuration about a longitudinal axis 172 (FIG. 14) that extends axially inwardly and axially outwardly relative to the flow direction of the fluid through the valve. The generally annular configuration of the resilient material defining the valve flange 160 is located around, and radially outwardly of, the longitudinal axis 172. The resilient material forming the flange 160 has a surface region defined at least in part by the following surfaces:

(A) a first surface 191 extending generally axially outwardly from the sleeve 154;

(B) a second surface 192 extending generally axially inwardly from the sleeve 154;

(C) a third surface 193 extending both generally axially outwardly and radially outwardly from the first surface 191;

(D) a fourth surface 194 extending both generally axially inwardly and radially outwardly from the second surface so that the third and fourth surfaces generally diverge;

(E) a fifth surface 195 extending from the third surface 193 both generally axially inwardly and radially outwardly;

(F) a sixth surface 196 extending from said fourth surface both generally axially outwardly and radially outwardly;

(G) a seventh surface or shoulder surface 197 extending generally axially outwardly from the sixth surface 196;

(H) an eighth surface 198 extending generally axially inwardly from the seventh surface 197;

(i) a ninth surface 199 extending generally axially outwardly from the eighth surface 198; and

(J) a tenth surface or lip 210 extending generally radially inwardly from the ninth surface 199.

The above-described configuration of the valve flange 160 is particularly suitable for accommodating swaging of the spout retention wall 120 (FIG. 12) by ultrasonic deformation into the inelastically deformed, retaining configuration shown in FIGS. 1 and 16.

The ultrasonic swaging of the spout retention wall 120 may be effected by substantially the same process as described above for ultrasonically swaging the pump housing retention wall 70 about the diaphragm flange 60. In a presently preferred process for ultrasonically swaging the spout retention wall 120, the ultrasonic horn applies a swaging force of about 1075 pounds to the wall 120. However, it is to be realized that other swaging processes could be employed, including non-ultrasonic swaging techniques.

In the presently most preferred process, the wall 120 is swaged against the outlet valve flange 160 so as to compress the flange 160 between about 0.000 inch and 0.004 inch, most preferably about 0.004 inch.

After the components have been assembled as described above to provide an operable pump 30, the pump 30 may be connected to a supply of fluid, such as liquid soap, and then operated or actuated to dispense the liquid. The pump 30 is especially well-suited for incorporation into a dispenser 10 of the type illustrated and described in the U.S. Pat. No. 6,216,916.

In any case, the pump 30 is actuated by pushing in on the flexible dome 52, either directly, or indirectly through intervening mechanical elements (such as the actuation lever 31 illustrated in the U.S. Pat. No. 6,216,916). The flexible, resilient dome 52 is pushed inwardly with sufficient force so that it pressurizes the liquid within the cavity and somewhat deforms or collapses as illustrated in FIG. 19 herein.

The pressurization of the liquid within the cavity of the dome 52 imposes a force on the inside surface of the diaphragm flap 56 over the inlet conduit seat 64. This establishes an even greater fluid-tight engagement between the exterior surface of the flap 56 and the seat 64. The pressurized liquid within the cavity of the dome 52 is then forced out through the outlet flow passage in the boss 44, into the outlet discharge structure or spout 36, and against the sleeve 154 of the outlet valve 38. This causes the outlet valve 38 to open as illustrated in FIG. 19.

When the user terminates the pushing force on the resilient dome 52, the dome 52 returns to its original, unstressed, outwardly convex configuration. This increases the volume of the cavity under the dome 52 so as to reduce the pressure within the cavity. The reduced pressure in the dome cavity forces the diaphragm flap 56 away from the seat 64 (as shown in FIG. 21). Liquid is typically always present in the inlet conduit 42 so that the liquid in the inlet conduit 42 can then flow past the open inlet flap 56 into the cavity in the diaphragm dome 52 and into the other discharge passages in the pump that communicate with the cavity. The outlet valve head 150 cannot open inwardly under the influence of reduced pressure in the diaphragm cavity because of the restraint structure surfaces 130 and 132 (FIG. 16). The restraint structure can also minimize the effects of hydraulic water hammer pressure on the outlet valve 38 when the diaphragm dome 52 is subjected to a high, rapidly applied actuating force.

When the pushing force has been released from the diaphragm dome 52, the pressure of the fluid in the discharge spout 36 returns to the substantially ambient atmospheric pressure (or slightly higher owing to the liquid static head in the pump). Then, owing to the inherent resiliency of the outlet valve 38, the outlet valve 38 returns to its normal self-sealing, closed configuration (FIGS. 1 and 14-16). In the preferred form of the outlet valve 38 illustrated, the valve 38 has sufficient resiliency to remain in the self-sealed, closed configuration even with liquid remaining in the pump above the valve because the static head pressure exerted by such liquid on the closed valve 38 is not sufficient to open the valve 38.

It will be readily apparent from the foregoing detailed description of the invention and from the illustrations thereof that numerous variations and modifications may be effected without departing from the true spirit and scope of the novel concepts or principles of this invention.

What is claimed is:

1. A diaphragm pump comprising:
(A) a diaphragm of resilient material molded to define
(1) a resiliently deformable, pressurizing portion that (a) has an undeformed convex configuration as viewed from the exterior, and (b) defines a concave receiving region as viewed from the interior for pressurizing fluid;
(2) a connecting member extending from the periphery of said pressurizing portion; and
(3) a mounting flange that (a) extends generally radially from the periphery of said connecting member, (b) is thicker than said connecting member, (c) has a first surface extending outwardly from said connecting member in the direction toward the exterior, and (d) has a second surface extending inwardly from said connecting member in the direction away from the exterior; and
B. a pump housing defining an inlet and outlet and further including a retention structure for retaining said diaphragm mounting flange, said retention structure including a projecting wall that has a lateral surface and an end surface, said wall end surface being spaced from said diaphragm connecting member when said pump is not pressurizing said fluid, said wall lateral surface being spaced from said diaphragm mounting flange second surface when said pump is not pressurizing said fluid whereby assembly of said diaphragm into said pump housing is facilitated.

2. The pump in accordance with claim 1 in which said mounting flange second surface defines a substantially interior cylindrical surface.

3. The pump in accordance with claim 1 in which said connecting member is arcuate.

4. The pump in accordance with claim 1 in which said connecting member defines a convex surface projecting toward, but not engaging, said retention structure projecting wall end surface.

5. The pump in accordance with claim 1 in which at least a portion of said retention structure projecting wall lateral surface is engageable by a portion of said mounting flange when said pump is pressurizing said fluid.

6. A diaphragm for a pump, said diaphragm comprising:
a resilient material molded to define
(A) a resiliently deformable, pressurizing portion that (1) includes an undeformed convex configuration when viewed from the exterior, and (2) defines a receiving region under said convex configuration for receiving fluid that can be pressurized by deforming said pressurized portion;
(B) a stress isolation connecting member extending from the periphery of said pressurizing portion, said stress isolation connecting member having a non-linear cross-sectional configuration; and
(C) a mounting flange that (1) extends from the periphery of said stress isolation connecting member, and (2) can be disposed in a retention structure of said pump.

7. The diaphragm in accordance with claim 6 in which said diaphragm includes an annular base wall around the bottom of said pressurizing portion; and in which said stress isolation connecting member has an arcuate cross section and connects said annular base wall with said mounting flange.

8. The diaphragm in accordance with claim 7 in which said arcuate cross section is of uniform thickness over at least a major portion of its radial length.

9. The diaphragm in accordance with claim 8 in which said arcuate cross section defines a concave annular channel around said pressurizing portion as viewed from the exterior.

10. A diaphragm for a pump having a retention structure that includes an inelastically deformable exterior retention wall, said diaphragm comprising:
a resilient material molded to define
(A) a resiliently deformable, pressurizing portion that (1) has an undeformed convex configuration as viewed from the exterior, and (2) defines a concave receiving region as viewed from the interior for pressurizing fluid; and
(B) a mounting flange that (1) is connected with the periphery of said pressurizing portion, (2) can be disposed in said pump so that said exterior retention wall can be inelastically deformed against said mounting flange, and (3) has a generally annular configuration of resilient material extending from the periphery of said sleeve wherein said material having a surface region defined in part by the following surfaces:
(a) inner and outer diverging surfaces wherein said inner diverging surface is inwardly of the location of the connection of said flange to said pressurizing portion and wherein said outer diverging surface is outwardly of the location of the connection of said flange to said pressurizing portion;
(b) a first corner surface extending from said outer diverging surface;
(c) a laterally extending surface extending from said first corner surface; and
(d) a second corner surface extending from said laterally extending surface.

11. The diaphragm pump in accordance with claim 10 in which said surface region of said generally annular configuration of resilient material further includes a laterally peripheral surface that has an outer margin and an inner margin wherein said outer margin is located laterally further from said pressurizing portion than is said inner margin.
